(19) United States
(12) Patent Application Publication
(10) Pub. No.: US 2026/0177362 A1
(43) Pub. Date: Jun. 25, 2026

(54) MAGNETIC PROJECTION AND CAPTURE

(71) Applicant: LAU Superconductors Inc., Hunt Valley, MD (US)

(72) Inventor: Wayne Chung Wei Lau, Geneva (CH)

(21) Appl. No.: 19/465,162

(22) Filed: Jan. 30, 2026

Related U.S. Application Data
(62) Division of application No. 18/108,456, filed on Feb. 10, 2023, now abandoned.
(60) Provisional application No. 63/309,958, filed on Feb. 14, 2022.
(60) Provisional application No. 63/310,309, filed on Feb. 15, 2022.
(60) Provisional application No. 63/351,668, filed on Jun. 13, 2022.
(60) Provisional application No. 63/400,674, filed on Aug. 24, 2022.
(60) Provisional application No. 63/401,021, filed on Aug. 25, 2022.

(51) Int. Cl. F42B 6/00; H01F 7/02; H01F 7/20

(52) U.S. Cl. CPC F42B 6/006; H01F 7/02; H01F 7/20

(57) ABSTRACT

A system for projecting includes a projector magnet and a magnetized projectile. The projector magnet and the magnetized projectile have opposing magnetic fields causing the magnetized projectile to be projected out of the projector magnet. The projector includes a friction reducing solenoid.

### CROSS REFERENCE TO OTHER APPLICATIONS

This application is a divisional of U.S. patent application Ser. No. 18/108,456 entitled MAGNETIC PROJECTION AND CAPTURE filed Feb. 10, 2023 which is incorporated herein by reference for all purposes, which claims priority to U.S. Provisional Ser. No. 63/309,958 (Attorney Docket No. LAUSP015+) entitled A DIPOLE COILGUN FOR MAGNETICALLY PROPELLING PROJECTILES, MISSILES AND OTHER OBJECTS, filed 14 Feb. 2022 which is incorporated herein by reference for all purposes.

U.S. patent application Ser. No. 18/108,456 claims priority to U.S. Provisional Ser. No. 63/310,309 (Attorney Docket No. LAUSP016+) entitled A DIPOLE COILGUN FOR MAGNETICALLY PROPELLING PROJECTILES, MISSILES AND OTHER OBJECTS AND APPLICATIONS OF FIBER REINFORCED HIGH TEMPERATURE SUPERCONDUCTORS AND MANUFACTURING METHODS FOR THE SAME, filed 15 Feb. 2022 which is incorporated herein by reference for all purposes.

U.S. patent application Ser. No. 18/108,456 claims priority to U.S. Provisional Ser. No. 63/351,668 (Attorney Docket No. LAUSP017+) entitled VARIOUS APPLICATIONS OF REINFORCED HIGH TEMPERATURE SUPERCONDUCTORS, REINFORCED LOW TEMPERATURE SUPERCONDUCTORS, AND MANUFACTURING METHODS FOR THE SAME, filed 13 Jun. 2022 which is incorporated herein by reference for all purposes.

U.S. patent application Ser. No. 18/108,456 claims priority to U.S. Provisional Ser. No. 63/400,674 (Attorney Docket No. LAUSP019+) entitled VARIOUS APPLICATIONS OF SUPERCONDUCTORS IN SPACE FOR LAUNCHING PROJECTILES AND PAYLOAD TRANSPORT, filed 24 Aug. 2022 which is incorporated herein by reference for all purposes.

U.S. patent application Ser. No. 18/108,456 claims priority to U.S. Provisional Ser. No. 63/401,021 (Attorney Docket No. LAUSP020+) entitled SUPERCONDUCTORS IN SPACE FOR LAUNCHING PROJECTILES AND PAYLOAD TRANSPORT, filed 25 Aug. 2022 which is incorporated herein by reference for all purposes.

### BACKGROUND OF THE INVENTION

Launching and propelling objects such as bullets, missiles, space payloads and other projectiles involves explosive chemical reactions involving gunpowder, rocket fuel and other material propellants.

This causes several problems:
The chemical reactions create explosive shocks, chemicals, and heat which are

harmful to nearby humans.
The chemicals are destroyed and cannot be re-used incurring substantial material expense for each launch.
The chemical reaction generates excess heat which much be dissipated without harm. This heat accumulates during multiple launches preventing rapid relaunching.
Material from the chemical reaction must be channel with substantial containment equipment to force the expanding material in a single vector direction along a projectile's axis of movement. This equipment is subject to considerable wear and tear requiring frequent and expensive maintenance and replacement.
Directing the projectile along its axis requires physical contact with a barrel that generates more heat from friction as well as more equipment wear and tear.
The reaction generates unusually large noise which not only harms humans but also attracts attention from adversaries looking to locate the launcher.
The reaction generates unusually large pulses of electro-magnetic radiation such as infrared radiation which can attract attention from adversaries looking to locate the launcher.

Also, the first high-temperature superconductor (HTS) was discovered in 1986. Its discoverers were immediately awarded the 1987 Nobel Prize in Physics partly because of expectations for rapid application. Superconductivity is the property of transmitting electricity with no or little resistance. In theory, superconducting materials can also create unlimitedly large magnetic fields.

The HTS break-through was the discovery of superconductivity in ceramic materials. Previously superconductivity was seen only in metallic superconductors which needed to be cooled below 30 K (−243.2° C.) to achieve superconductivity. Such temperatures could in practice be obtained using liquid helium or liquid hydrogen which are expensive to use, increasingly rare in the case of helium, and/or dangerously explosive in the case of hydrogen. In contrast, HTS can achieve superconductivity at temperatures as high as 138 K (−135° C.) and can be cooled using substances such as liquid nitrogen, which is commercially widely available, stable, and inexpensive.

Unfortunately after over three decades of intense experimental and theoretical research, with over 100,000 published papers on the subject and numerous early patents (nearly all expired), no widely accepted theory explains the properties of HTS materials, and no significant HTS applications have been found to be practical.

This reflects four problems: 1) unlike metals which are commonly used to transmit electricity, HTS ceramics are brittle making them expensive to manufacture and difficult to form into wires and other useful shapes; 2) highest performing HTSs are single crystals (bulk) superconductors where the entire sample is a single molecular lattice where superconductivity fails with the slightest lattice crack, 3) HTS do not form large, continuous superconducting domains, but clusters of micro-domains within which superconductivity occurs; and 4) the HTS production process is complicated requiring a multiple calcination of ingredients at high temperatures range from 800° C. to 950° C. for several hours following sintering, which is done at 950° C. in an oxygen atmosphere where oxygen stoichiometry is very crucial for obtaining the superconducting compound.

Slow cooling in an oxygen atmosphere turns the material superconductive involving both the uptake and loss of oxygen.

The complex role of oxygen in production prohibits the use of most reinforcing materials to relieve the brittleness and cracking described above. This is because nearly all potential materials, which are stable across this process'high temperature such as metals, carbon, composites, ceramics, etc., oxidize during this process, which interferes with the creation of the HTS material. The oxidation either creates impurities or depletes oxygen at critical times in the production process and crystal formation.

Current attempts to find useful HTS materials focus on external reinforcement such as packing-in-tube (PIT) wire production, encasing HTS in durable materials like stainless steel, or additive processes such as attempting to apply HTS as a coating on film or tape substrates (Coated). Both PIT and external encasing are difficult to produce economically in shapes and constructions for practical applications. Coated techniques which attempt to grow HTS on reinforcement substrates have limited commercial use and, to date, have not produced significantly robust HTS components for most applications. For example, attempts have been made to use HTS in electrical applications such as Superconductor Fault Current Limiters (SFCL), Superconductor Magnetic Energy Storage (SMES), transformers, and transmission cables where strength is not critical. But these have not yet resulted in widespread HTS for technical and economic reasons.

Attempts have been made to internally reinforce HTS using discontinuous fibers (also known as chopped fibers) and particles. These have generally failed due to a) contamination during production and/or b) agglomeration of the discontinuous particles/fibers during the melt phase of production. For agglomeration, sintering powders are melted into liquid form. When in liquid, discontinuous pieces move and stick together (agglomerate) forming masses which disrupt crystal formation. These agglomerations create cracks and fault planes which reduce the strength of and disintegrate the final HTS crystal. This also causes discontinuous fibers and particles to react with HTS components during HTS formation possibly contaminating the process.

### BRIEF DESCRIPTION OF THE DRAWINGS

Various embodiments of the invention are disclosed in the following detailed description and the accompanying drawings.

FIG. 1A is a diagram illustrating an embodiment of a system for magnetic projection.

FIG. 1B is a diagram illustrating an embodiment of a system for magnetic projection.

FIG. 1C is a diagram illustrating an embodiment of a system for magnetic projection.

FIG. 1D is a diagram illustrating an embodiment of a magnetized projectile.

FIG. 1E is a diagram illustrating an embodiment of electrodes.

FIG. 1F is a diagram illustrating an embodiment of a cross section showing a magnetized projectile within a bore of a projector magnet.

FIG. 2A is a diagram illustrating an embodiment of a system for projection.

FIG. 2B is a diagram illustrating an embodiment of a system for projection.

FIG. 2C is a diagram illustrating an embodiment of a system for projection.

FIG. 2D is a diagram illustrating an embodiment of a system for projection.

FIG. 3A is a diagram illustrating an embodiment of a slice view of system for projection.

FIG. 3B is a diagram illustrating an embodiment of a slice view of system for projection.

FIG. 3C is a diagram illustrating an embodiment of a slice view of system for projection.

FIG. 4 is a diagram illustrating an embodiment of a slice view of a system for projection and capture.

FIG. 5A is a diagram illustrating an embodiment of a system for projection with multiple stages.

FIG. 5B is a diagram illustrating an embodiment of a system for projection with multiple stages.

FIG. 6A is a diagram illustrating an embodiment of a frictionless barrel.

FIG. 6B is a diagram illustrating an embodiment of a slice view of a frictionless barrel.

FIG. 7 is a diagram illustrating an embodiment of a system for asteroid propulsion.

FIG. 8A is a diagram illustrating an embodiment of propelling material for an asteroid propulsion system.

FIG. 8B is a diagram illustrating an embodiment of propelling material for an asteroid propulsion system.

FIG. 8C is a diagram illustrating an embodiment of propelling material for an asteroid propulsion system.

FIG. 8D is a diagram illustrating an embodiment of propelling material for an asteroid propulsion system.

FIG. 9A is a diagram illustrating an embodiment of propelling ferromagnetic material for an asteroid propulsion system.

FIG. 9B is a diagram illustrating an embodiment of propelling ferromagnetic material for an asteroid propulsion system.

FIG. 9C is a diagram illustrating an embodiment of propelling ferromagnetic material for an asteroid propulsion system.

FIG. 9D is a diagram illustrating an embodiment of propelling ferromagnetic material for an asteroid propulsion system.

FIG. 10 is a flow diagram illustrating an embodiment of a process for a system for projecting a projectile.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for projection and capture is disclosed. The system comprises a projector magnet and a magnetized projectile. The projector magnet and the magnetized projectile have opposing magnetic fields causing the magnetized projectile to be projected out of the projector magnet.

The system uses magnetism as a driving force for propelling an object and in some cases for braking the object at a destination. In some embodiments, the magnetic field is generated using currents that flow in a superconductor. In various embodiments, the superconductor comprises a high temperature super conductor, a reinforced high temperature superconductor, or any other appropriate conductor. In various embodiments, the magnetized projectile has a magnetic field created by a permanent magnet or by a projectile solenoid. In various embodiments, the projectile solenoid comprises one or more of: metal conductors, high temperature superconductors, reinforced high temperature superconductors, low temperature superconductors, superconducting tapes or wires, and/or any other appropriate solenoid conductor. In some embodiments, the projector magnet includes electrodes for providing current to a magnetized projectile, and wherein the magnetized projectile includes contacts for electrically connecting to the electrodes. In some embodiments, the projector magnet includes grooves for maintaining rotational orientation between the projector magnet and the magnetized projectile. In various embodiments, the grooves are straight, spiraled, or any other appropriate shape. In some embodiments, the system further comprises one or more additional projector magnets. In some embodiments, the projector magnet and the one or more additional projector magnets have magnetic fields oriented in a same direction. In some embodiments, the projector magnet and the one or more additional projector magnets have magnetic fields oriented in alternating directions. In some embodiments, the projector magnet and the one or more additional projector magnets have electrodes for switching on a magnetic field of the magnetized projectile. In some embodiments, the system further comprises a guide, wherein the guide guides the magnetized projectile between the projector magnet and one of the one or more projector magnets or between a second projector magnet of the one or more projector magnets and a third projector magnet of the one or more projector magnets (e.g., between any adjacent set of projector magnets). In some embodiments, the guide selectively omits electrodes for switching off the magnetic field of the magnetized projectile at desired positions (e.g., the magnetic field of the projectile is off in portions of the path through the projector magnets).

In some embodiments, the projector includes a friction reducing solenoid. In some embodiments, the magnetized projectile includes a current source to switch on a magnetic field of the magnetized projectile for inductive capture. In some embodiments, the projector or the magnetized projectile comprise one or more stages for projection. In some embodiments, the magnetized projectile projects material.

In some embodiments, the magnetized projectile projects material. In some embodiments, the magnetized projectile projects ferromagnetic material.

In some embodiments, a method for projecting comprises providing a projector magnet; and providing a magnetized projectile, wherein the projector magnet and the magnetized projectile have opposing magnetic fields causing the magnetized projectile to be projected out of the projector magnet.

In some embodiments, a method for projecting comprising receiving indication to project projectile; causing current to flow to projectile via electrodes and contacts to magnetize projectile to cause propelling of projectile from projector; and stopping current by breaking connection between projectile contacts and projector electrodes.

In some embodiments, a reinforced superconductor comprises one or more continuous fibers that is/are embedded in a high temperature superconducting (HTS) material. The fibers are of sufficiently long length or sufficiently large aspect ratio (the ratio of fiber length to width) such that the fibers do not migrate, agglomerate, nor react sufficiently during HTS sintering and crystallization to weaken the final HTS material below that of unreinforced HTS. Fibers can be connected together in structures so that they do not migrate, agglomerate nor react sufficiently during HTS sintering and crystallization to weaken the final HTS material below that of unreinforced HTS. In some embodiments, the fibers are long in the event that the fibers span the HTS from one edge to another. In various embodiments, the fibers are 3, 4, 5, 6, 7, 8, 9, 10, 20, 30, 50 mm long, or any other appropriate length. In some embodiments, the fibers are composed of multiple filaments and/or non-continuous strands which may or may not be composed as threads and/or braids.

In some embodiments, the one or more continuous fibers is/are comprised of an element which a) has a high melting point and b) forms a very durable oxide form that prevents contamination of a high temperature superconducting material. In some embodiments, the one or more continuous fibers comprise SiC fiber. In various embodiments, the one or more fibers comprise Silicon (Si), Silicon Nitride (Si₃N₄), Silicates including Silicon Dioxide (SiO₂), Boron (B), Boron Carbide (B₄C), Boron Nitride (BN), Chromium (Cr), Chromium Carbides (Cr₃C₂, Cr₇C₃, Cr₂₃C₆), Chromium Nitrides (CrN, Cr₂N), Hafnium Carbide (HfC), Zirconium Carbide (ZrC), Zirconium Nitride (ZrN), Zirconium Diboride (ZrB₂), Titanium (Ti), Titanium Carbide (TiC), Titanium nitride (TiN), Tungsten Carbide (WC), Aluminum (Al), Alumina (Al₂O₃), Aluminum Carbide (Al₄C3), Aluminum Nitride (AlN), Titanium Aluminum Nitride (TiAlN), Aluminum Titanium Nitride (AlTiN), or any other appropriate material. These materials are referred to herein as Reinforcing Materials.

A reinforced high temperature superconducting material is disclosed. The high temperature superconducting material has zero electrical resistance at a temperature above 25° K. In various embodiments, the high temperature superconducting material comprises one or more of the following: a ceramic material, a copper oxide material, a rare earth copper oxide material (RE)BCO (e.g., (RE)Ba₂Cu₃O₇), an iron arsenide material, an iron selenide material, a LaBaCuO material, a LaSrCuO material, a LaSrCaCuO material, a YBaCuO material, a BiSrCaCuO material, a TiBaCaCuO material, a HgBACaCuO material, a HgTiBaCaCuO material, a LnFeAs(O, F) material, a (Ba, K, Li, Na)FeAs material, a FeSe material, a MgB material, a BKBO material, a RbCsC material, a YbPdBC material, a NbGe material, or any other appropriate material. Note that RE stands for a rare earth element, where the rare earth elements include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). These materials are typically made by heating the component powders in the appropriate proportions until they anneal and then cooling until a crystal is formed. These materials are referred to herein as High Temperature Superconductors or HTS.

In some embodiments, the one or more continuous fibers are arranged in an array. In various embodiments, the array comprises one of the following: a one dimensional array, a two dimensional array, a three dimensional array, or any other appropriate array. In some embodiments, the two or more continuous fibers are connected or coupled to each other. In some embodiments, the two or more continuous fibers are not connected nor coupled to each other. In various embodiments, the one or more fibers are arranged in parallel lines, in parallel curves, or any other appropriate reinforcement arrangement.

In various embodiments, the high temperature superconductive material is shaped using subtractive cutting, is shaped using cutting and dividing, or any other process for creating a shape. In various embodiments, the high temperature superconductive material is produced using a batch process, a continuous process, or any other appropriate process.

In some embodiments, the one or more fibers are pre-stressed during manufacturing (e.g., put under mechanical tension—for example, by pulling on the ends of the fiber). In various embodiments, the one or more fibers are used for cooling the high temperature superconducting material, are used to heat the high temperature superconducting material, are used to transmit electrical signals into the high temperature superconducting material, or any other appropriate use within the high temperature superconducting material. In some embodiments, the fiber comprises a composite fiber, where the components of the fiber are selected to enhance or be compatible with the property desired (e.g., cooling, heating, and/or transmitting electricity, etc.).

In some embodiments, continuous, long fiber is used for physical internal reinforcement of an HTS material to prevent contamination during crystal formation and cracking of the final crystal which causes the superconductivity of HTS material to fail. Long continuous fiber is distributed through the HTS sintering components powder then processed with the HTS sample through a sintering, crystallization, and cooling process. The use of long continuous fiber prevents problems when fibers agglomerate and react causing weakness in HTS crystal. In some embodiments, discontinuous fibers of approximately 4 mm in length that are added to HTS component powders before sintering physically reinforce an HTS material and prevent contamination during crystal formation and cracking of the final HTS crystal. These agglomerations and reactions are especially acute during the melt phase of HTS crystal production. The length of long continuous fibers, especially when connected or held fixed, prevents the fibers from moving, clumping, and reacting unnecessarily to the detriment of HTS crystal formation. In some embodiments, the fibers are long in the event that the fibers span the HTS from one edge to another and/or just shy of or just beyond or way beyond the edge(s) of the HTS crystal. In various embodiments, the fibers are 3, 4, 5, 6, 7, 8, 9, 10, 20, 30, 50 mm long, or any other appropriate length to prevent agglomeration.

In some embodiments, carbon fiber (e.g., SiC fiber) and/or other fiber is a strong reinforcing material which is stable over the wide range of temperatures involved in sintering, crystallizing and processing bulk HTS crystal;

In some embodiments, although oxygen reacts readily with most materials, the specified fibers create a durable oxide layer that prevents contamination of a high temperature superconducting material. For example, SiC carbon fiber creates a durable layer of silicon dioxide (SiO₂) from a reaction of silicon Si with oxygen O during the initial heating of the HTS sintering, in which the component powders are melted into a liquid phase. This SiO₂ layer prohibits further reaction with oxygen during the remaining HTS production process. This process is similar to how aluminum (Al), which normally reacts readily with oxygen, forms a durable coat of aluminum oxide Al₂O₃, which prevents further reactions. The oxide layer allows aluminum to be used safely for foil, pots, and pans without the fear of either an explosive chemical reaction or aluminum poisoning (except in the case of highly acidic foods like rhubarb which can dissolve the Al₂O₃ coating during cooking).

In some embodiments, the use of continuous, long fiber permits the fiber to retain its position in the metal phase liquid and prevents the agglomeration seen with discontinuous fibers and particles, which ultimately weakens and disintegrates the HTS crystal.

In various embodiments, continuous, long fiber can be formed into a variety of simple reinforcement structures involving unconnected fibers such as single planes of one dimensional fiber arrays, two dimensional fiber arrays with alternating stacked layers of planes in orthogonal directions, full three dimensional unconnected arrays or lattices of fibers, or any other appropriate reinforcement arrangements.

In some embodiments, by connecting continuous, long fiber, a variety of reinforcement structures like single and layered two dimensional nets as well as three dimensional connected mesh structures can be made. For example, these structures, nets, or meshes create an internal reinforcement similar to concrete reinforcement that strengthens the material by redistributing stresses and strains, which prevents cracking.

In some embodiments, by using both linear and non-linear, unconnected and connected continuous long fiber, complex reinforcement structures can be formed for any desired geometry of HTS superconductor.

In some embodiments, fiber reinforcement permits HTS components to be produced cheaply and with precision through the technique of Subtractive Sculpting (e.g., the removal of material to achieve a desired shape—for example, by cutting, carving, scraping, grinding, etc.). Until now attempts at producing usable HTS components exclusively focused on either creating thin single crystal films through two-dimensional deposition on substrates or bulk three-dimensional HTS crystals in molds or other fixed containers. These methods are expensive, restrict the shape and size of components, and require the custom manufacture of each component to exact specifications making it extremely difficult to physically modify a component after it is produced. Fiber reinforcement strengthens and reduces the brittleness of a bulk HTS allowing parts to be sculpted (i.e., carved, cut, ground or otherwise extracted away) from a block of HTS material without disrupting the superconductivity of the crystal lattice. Thus, an unlimited variety of HTS component geometries can be produced including wires, rods, spirals, films, tapes, plates, blocks, spheres and three-dimensional complex forms for use in specific electric and magnetic applications. Subtractive Sculpting also allows more precise component manufacture by eliminating geometric uncertainties in thermal expansion/contraction as HTS crystallizes and cools during production. Cooling causes thermal expansion and contraction, which is difficult to predict, and varies greatly depending on an HTS crystal's internal cooling temperature gradients and shape. Production using molds and film deposition are prone to such thermal uncertainties since their external reinforcement cannot be easily modified once the HTS crystal has formed. The much greater manufacturing precision provided by Subtractive Sculpting due to fiber internal reinforcement will allow much less wastage of less-than-perfectly formed HTS components. The efficiency will substantially reduce the cost of fiber reinforced HTS components leading to more commercial applications.

In some embodiments, fiber reinforcement allows a single production block to be cut in to a large number and/or variety of different components. This increases production efficiency and reduces costs leading to more commercial applications.

In some embodiments, fiber reinforcement (e.g., SiC and/or other fiber reinforcement) also makes HTS and proto-HTS materials strong enough for Continuous HTS Production which will significantly reduce manufacturing cost leading to HTS use in more applications. Currently, HTS is produced in batches where single bulk crystals or films are first sintered/deposited then allowed to cool under controlled conditions to allow crystal growth. While suitable for research, batch production is inefficient and expensive requiring considerable labor for each batch and leaving most equipment unused during each production run. Continuous HTS Production is a multi-stage process where: 1) fiber reinforcement is placed within a continuous tube sheath or are formed into a shape by compression prior to or at the entrance to the continuous production line, 2) constituent HTS chemicals in sintering powder form are mixed and place with the fiber reinforcement in the tube or shape, 3) the HTS is then packed and heated to sintering temperatures as the tube or shape is moved through a processing oven machine, 4) the tube or shape then moves through a cooling process where a single long HTS crystal continuously forms, 5) once crystallized, the continuous HTS crystal tube or shape is cooled to room temperature, and 6) the HTS tube or shape is then cut at intervals to produce individual bulk single crystal HTS blocks. The individual blocks are then Subtractively Sculpted into individual components.

Continuous production requires that the single HTS crystal be strong enough to withstand the strains and stresses of continuous movement during production. This is done by placing fiber reinforcement with the sintering component powders in the continuous tube or shape before sintering. The reinforcement reduces the brittleness of and strengthens the HTS such that the continuous tube of HTS can be transported seamlessly through mixing, packing, sintering, cooling, and cutting without breaking the HTS' essential single crystal structure.

In various embodiments, features of the reinforced HTS material include:
using continuous, long fiber silicon carbide fiber to reinforce HTS to prevent contamination during crystal formation and cracking of the HTS crystal;
using unconnected continuous, long fibers placed in arrays to reinforce and strengthen HTS; and
using connected continuous, long fibers placed in two and three dimensional reinforcement structures.

In various embodiments, reinforced HTS material are produced using:
Subtractive Sculpting, where HTS material is extracted through a sculptive process rather than the additive process of external molding and film/tape deposition which will increase production efficiency and reduce costs leading to more commercial applications;
Cutting and dividing single HTS blocks into a large number and/or variety of different components which will increase production efficiency and reduce costs leading to more commercial applications;
Continuously Producing HTS to significantly reduce production cost and time compared to current batch production;

In some embodiments, a system launches projectiles with opposing magnetic fields created by positioning a magnetized projectile (e.g., a magnetized projectile) in a projector magnet (e.g., a projector magnet) with the opposite magnetic polarity. In some embodiments, a dipole coilgun comprises a system of a magnetized projectile and projectile magnet together with accompanying equipment and systems.

In some embodiments, the projector magnet and the magnetized projectile create opposing magnetic fields, which create forces which push the magnetized projectile out of the projector magnet. If the magnetized projectile is positioned at a place inside the projector magnet where the opposing magnetic fields are equal on both the front and back of the magnetized projectile, the magnetized projectile is stable and does not move. But when the magnetized projectile is positioned where the opposing magnetic fields on the magnetized projectile's front is different from the magnetic fields on the magnetized projectile's back (for example at a position closer to the end of the projector magnet), force on the magnetized projectile's front will be different from the force on the magnetized projectile's back. The difference in forces will push the magnetized projectile out of the projector magnet along the solenoid's axis.

In some embodiments, the projector magnet is comprised of a solenoid, which in turn can be made of metal conductors such as copper or silver, and/or High Temperature Superconductors, and/or Reinforced High Temperature Superconductors, and/or Low Temperature Superconductors, and/or any material which conducts electricity thereby creating a magnetic field within the solenoid.

In some embodiments, solenoids can contain multiple layers of conducting wire and can be of any size as long as the magnetized projectile fits within the projector magnet's empty core.

In some embodiments, the magnetized projectile exerts force on another object outside the projector magnet, which in turn propels the object forward making the object another projectile. The propelled object can thus be larger than the magnetized projectile or the projector magnet.

In various embodiments, the magnetized projectile's magnetic field is created by permanent magnets in the magnetized projectile. In some embodiments, a projector magnet's solenoid magnetic field is turned on to create a force propelling the projectile out of the projector magnet (e.g., by running a current through the solenoid).

In some embodiments, the magnetized projectile's magnetic field is created by a solenoid in the magnetized projectile that is provided current through electrodes on the projector, which control whether the magnetic field is on or off or how strong it is. In some embodiments, the projector magnet comprises a solenoid magnet that is provided current so that it can be on or off or different strengths.

In various embodiments, the projector magnet comprises one or more of: metal conductors, high temperature superconductors, reinforced high temperature superconductors, low temperature superconductors, and/or any other appropriate conductor.

In various embodiments, the magnetized projectile's magnetic field is created by solenoids made of metal conductors such as copper or silver, and/or High Temperature Superconductors, and/or Reinforced High Temperature Superconductors, and/or Low Temperature Superconductors, and/or solenoids of any material which conducts electricity thereby capable of creating a magnetic field in the magnetized projectile.

In various embodiments, where superconductors are used for projector magnets and/or for magnetized projectiles, the superconducting solenoids are wound and continuously operated with power or may utilize a persistence switch as is common in continuously magnetized systems such as MRI or other large scale magnets utilizing superconductors.

In some embodiments, the magnetized projectile is a Sabot containing the aforementioned magnets and solenoids with a void central area capable of containing objects and materials.

In some embodiments, the magnetized projectile/Sabot contains a battery to supply electric power for its solenoid and/or contacts for power to be supplied from an external source.

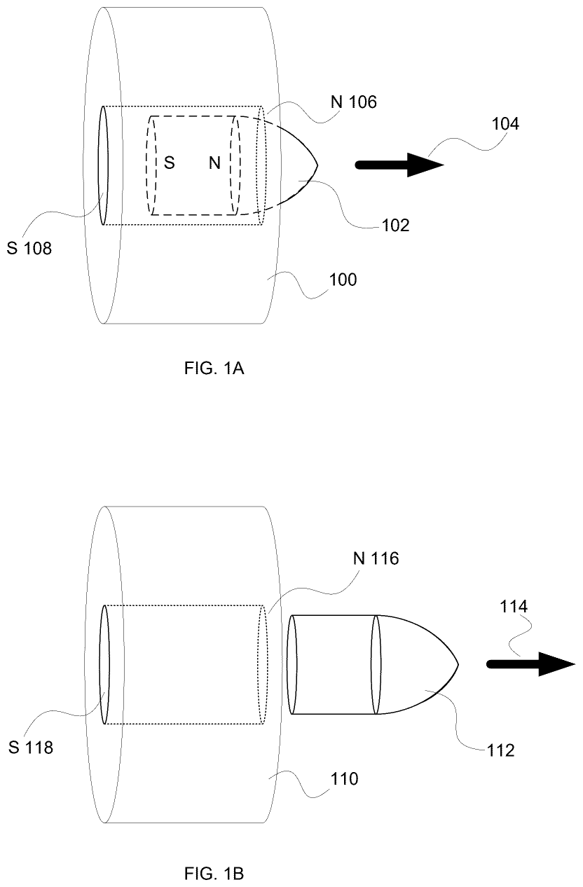

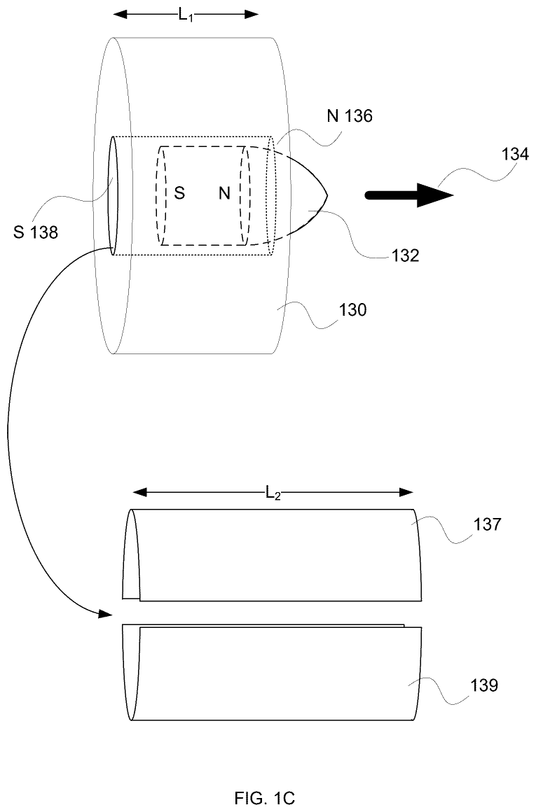

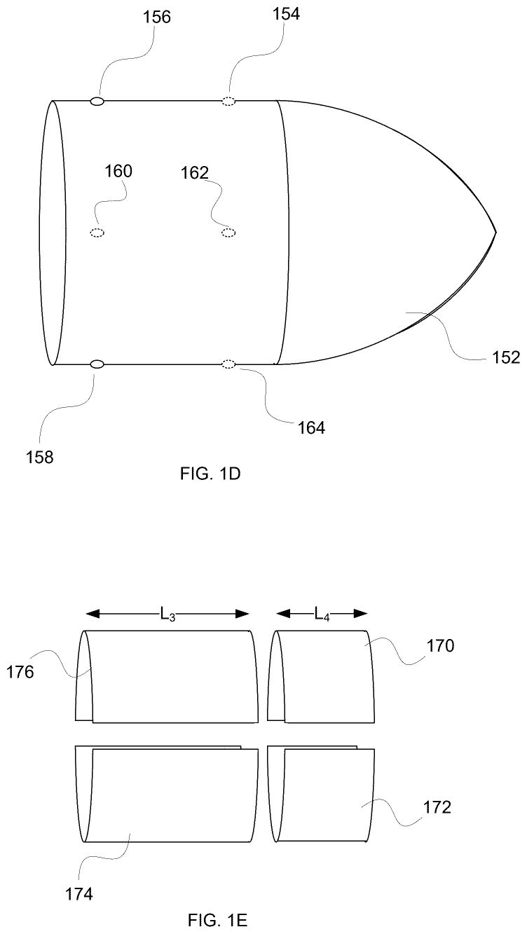

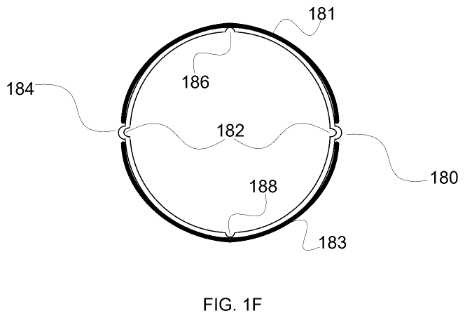

FIG. 1A is a diagram illustrating an embodiment of a system for magnetic projection. In the example shown, projector magnet 100 has magnetic pole N 106 on the right side and magnetic pole S 108 on the left side. Magnetized projectile 102 (with magnetic pole N on the right and magnetic pole S on the left) is project out by the force from the opposing magnetic fields in direction 104. In some embodiments, projector magnet 100 and/or magnetized projectile 102 are initially off (e.g., either magnet in projector magnet 100 or magnet in magnetized projectile 102 is off or both the magnet in projector magnet 100 and the magnet in magnetized projectile 102 are off) so that there is no opposing magnetic force between projector magnet 100 and magnetized projectile 102 when magnetized projectile 102 is placed inside projector magnet 100 ready to be projected. In some embodiments, when the projection of magnetized projectile 102 is desired from projector magnet 100, both the magnet the magnet in projector magnet 100 and the magnet in magnetized projectile 102 are set to be turned on at the same time forcing magnetized projectile out in direction 104.

FIG. 1B is a diagram illustrating an embodiment of a system for magnetic projection. In the example shown, projector magnet 110 has magnetic pole N 116 on the right side and magnetic pole S 118 on the left side. Magnetized projectile 112 (with no magnetic poles; magnetic field of magnetized projectile 112 has been switched off) has been projected out by the force from the opposing magnetic fields in direction 114 and, with the magnetic field of magnetized projectile 112 off, there is no attractive force between magnetized projectile 112 and projector magnet 110 once the magnetized projectile 112 has left projector magnet 110.

FIG. 1C is a diagram illustrating an embodiment of a system for magnetic projection. In the example shown, projector magnet 130 has length L₁ and magnetic pole N 136 on the right side and magnetic pole S 138 on the left side. Magnetized projectile 132 (with magnetic pole N on the right and magnetic pole S on the left) is project out by the force from the opposing magnetic fields in direction 134. In some embodiments, projector magnet 130 and/or magnetized projectile 132 are initially off (e.g., either magnet in projector magnet 130 or magnet in magnetized projectile 132 is off or both the magnet in projector magnet 130 and the magnet in magnetized projectile 132 are off) so that there is no opposing magnetic force between projector magnet 130 and magnetized projectile 132 when magnetized projectile 132 is placed inside projector magnet 130 ready to be projected. In some embodiments, when the projection of magnetized projectile 132 is desired from projector magnet 100, both the magnet the magnet in projector magnet 130 and the magnet in magnetized projectile 132 are set to be turned on at the same time forcing magnetized projectile out in direction 134. In the example shown, projector magnet 130 has two electrodes (e.g., top electrode 137 and bottom electrode 139) for delivering current to a solenoid on magnetized projectile 132. The two electrodes have length L₂ that enables the magnetic field of magnetized projectile 132 to be switched on/off dependent on the position of magnetized projectile 132 (and the position of the contacts on the outer edge). In various embodiments, length L₁ is the same as L₂ or is different from L₂, L₁ overlaps L₂ completely or partially, or L₂ protrudes L₁ to the left or right in the image. In addition, in the case of magnetized projectile 132 being in a position for which the contacts are electrically connected to the two electrodes (e.g., top electrode 137 and bottom electrode 139), the magnetic field for magnetized projectile 132 can be switched on and off by either supplying current through the two electrodes or not. The length (L₂) will automatically turn off the current to magnetized projectile 132 when magnetized projectile 132 moves and breaks connection between the two electrodes and contacts on the surface of magnetized projectile 132.

FIG. 1D is a diagram illustrating an embodiment of a magnetized projectile. In some embodiments, magnetized projectile 152 is used to implement magnetized projectile 102 of FIG. 1A, magnetized projectile 112 of FIG. 1B, and/or magnetized projectile 132 of FIG. 1C. In the example shown, magnetized projectile 152 includes surface protrusions. Surface protrusions can be contacts for electrical connections with electrodes of a magnet projector—for example, projection 156 and projection 158. Or, surface projections can be for stability and for minimizing contact with the inner walls of the projector magnet—for example, projections 154, projection 160, projection 162, and projection 164. In some embodiments, contacts (e.g., projection 156 and projection 158) are positioned 180 degrees apart around the circumference of magnetized projectile 152 (e.g., to match the split electrodes located on the inner diameter of the projector magnet). In various embodiments, contacts (e.g., projection 156 and projection 158) are positioned toward the aft end of, in the middle section of, and/or toward the front end of magnetized projectile 152. In some embodiments, there are more than one pair of contacts. In some embodiments, some projections protrude farther than others and are used to guide magnetized projectile 152 (e.g., by having the protruding projections travel in a groove on the inner diameter of projector magnet). In various embodiments, the groove are straight or spiraled to have magnetized projectile 152 travel straight without spin or with spin as it is propelled from a projector magnet.

FIG. 1E is a diagram illustrating an embodiment of electrodes. In some embodiments, the electrodes of FIG. 1E are used instead of electrode 137 and electrode 139 of FIG. 1C. In the example shown, a projector magnet has four associated electrodes (e.g., top electrode 176, top electrode 170, bottom electrode 174, and bottom electrode 172) for delivering current to a solenoid on a magnetized projectile. The two pairs of electrodes have length L₃ and L₄, respectively, that enable the magnetic field of the magnetized projectile to be switched on/off and to change polarity (if desired) dependent on the position of the magnetized projectile (and the position of the contacts on the outer edge). In various embodiments, the length of a projector magnet is the same as the combined lengths of L₃ or L₄, is different from L₃ or L₄, the length of a projector overlaps L₃ and L₄ completely or partially, or L₃ or L₄ protrude the length of a projector to the left or right in the image. In addition, in the case of the magnetized projectile being in a position for which the contacts are electrically connected to either of the two pairs of electrodes (e.g., (top electrode 176 and bottom electrode 174) or (top electrode 170 and bottom electrode 172)), the magnetic field for the magnetized projectile can be switched on and off by either supplying current through the two electrodes or not. The length (L₃ or L₄) will automatically turn off the current to the magnetized projectile when the magnetized projectile moves and breaks connection between the two electrodes and contacts on the surface of the magnetized projectile.

FIG. 1F is a diagram illustrating an embodiment of a cross section showing a magnetized projectile within a bore of a projector magnet. In some embodiments, magnetized projectile of FIG. 1F and electrode and inner bore surface of projector magnet of FIG. 1F are used to implement projector magnet 130, electrode 137, electrode 139, and magnetized projectile 132 of FIG. 1C. In the example shown, inner bore surface of a projector magnet comprises electrode 181 and electrode 183 and groove 180 and groove 184. Magnetized projectile outer diameter includes contact 186 and contact 188 to electrically connect a solenoid of magnetized projectile and electrode 183 and electrode 181. Magnetized projectile outer diameter further includes projections 182 that guide magnetized projectile as it travels down the inner bore of a projector magnet. Projections 182 can maintain appropriate alignment between a projector magnet and a magnetized projectile.

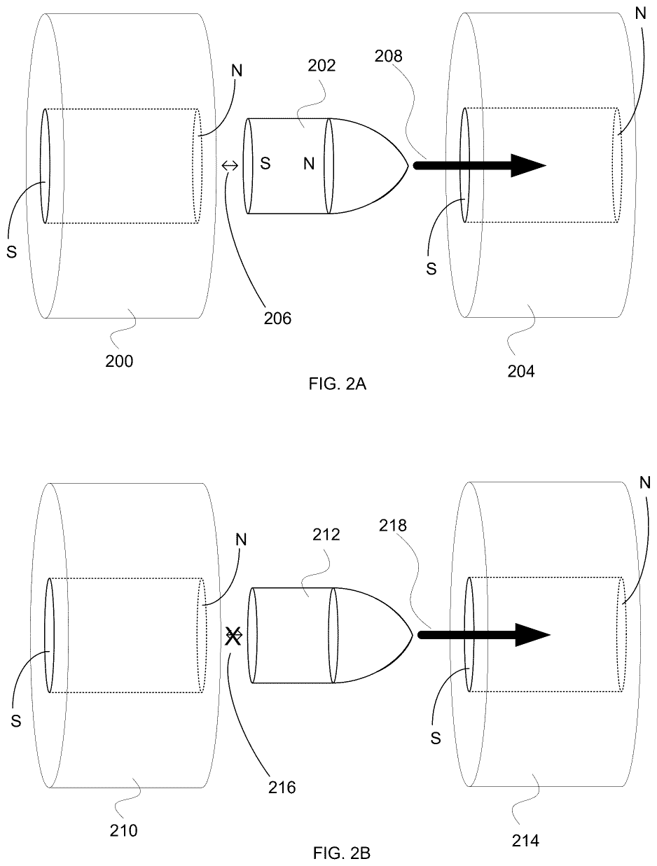

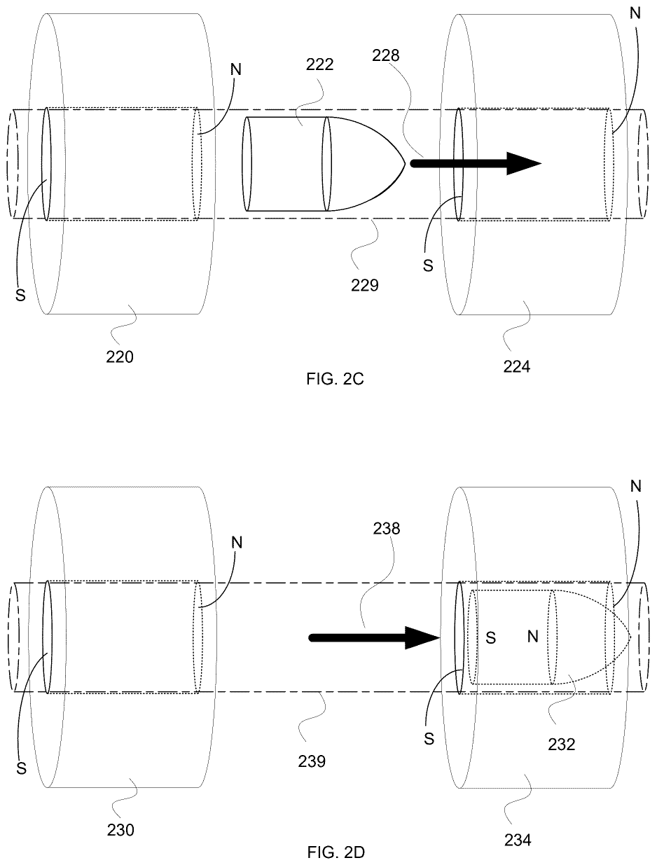

FIG. 2A is a diagram illustrating an embodiment of a system for projection. In the example shown, first stage projector magnet 200 with magnetic south pole to the left in FIG. 2A has propelled magnetized projectile 202 in direction 208 towards the right in FIG. 2A. In the position shown, magnetized projectile 202 with magnetic south pole to the left and magnetic north pole to the right in FIG. 2A feels an attractive force 206, which would slow magnetized projectile 202 in its motion in direction 208. At some position, magnetized projectile 202 is attracted by magnetic south pole of second stage projector magnet 204 and is propelled further along direction 208 using the magnetic field between magnetic south pole of second stage projector magnet 204 and magnetic north pole of second stage projector magnet 204.

FIG. 2B is a diagram illustrating an embodiment of a system for projection. In the example shown, first stage projector magnet 210 with magnetic south pole to the left in FIG. 2B has propelled magnetized projectile 212 in direction 218 towards the right in FIG. 2B. In the position shown, magnetized projectile 212 which is not magnetized does not feel an attractive force 216, which would slow magnetized projectile 212 in its motion in direction 218. At some position, magnetized projectile 212 is again magnetized when closer or inside second stage projector magnet 214 is attracted by magnetic south pole of second stage projector magnet 214 and is propelled further along direction 218 using the magnetic field between magnetic south pole of second stage projector magnet 214 and magnetic north pole of second stage projector magnet 214. In some embodiments, appropriate positioning of electrodes near first stage projector magnet 210 (not shown) or second stage projector magnet 214 (not shown) and contacts on magnetized projectile 212 are used to turn on and off the magnetic field of magnetized projectile 212 to create force to propel magnetized projectile 212 in direction 218.

FIG. 2C is a diagram illustrating an embodiment of a system for projection. In the example shown, first stage projector magnet 220 with magnetic south pole to the left in FIG. 2C has propelled magnetized projectile 222 in direction 228 towards the right in FIG. 2C. In the position shown, magnetized projectile 222 is guided in guide tube 229. At some position, magnetized projectile 222 is again magnetized when closer or inside second stage projector magnet 224 is attracted by magnetic south pole of second stage projector magnet 224 and is propelled further along direction 228 using the magnetic field between magnetic south pole of second stage projector magnet 224 and magnetic north pole of second stage projector magnet 224. In some embodiments, appropriate positioning of electrodes along inner bore of guide tube 229 near first stage projector magnet 220 (not shown) or second stage projector magnet 224 (not shown) and contacts on magnetized projectile 222 are used to turn on and off the magnetic field of magnetized projectile 222 to create force to propel magnetized projectile 222 in direction 228.

FIG. 2D is a diagram illustrating an embodiment of a system for projection. In the example shown, first stage projector magnet 230 with magnetic south pole to the left in FIG. 2D has propelled magnetized projectile 232 in direction 238 towards the right in FIG. 2D. In the position shown, magnetized projectile 232 is guided in guide tube 239. At some position, magnetized projectile 232 is again magnetized when closer or inside second stage projector magnet 234 is attracted by magnetic south pole of second stage projector magnet 234 and is propelled further along direction 238 using the magnetic field between magnetic south pole of second stage projector magnet 234 and magnetic north pole of second stage projector magnet 234. In some embodiments, appropriate positioning of electrodes along inner bore of guide tube 239 near first stage projector magnet 230 (not shown) or second stage projector magnet 234 (not shown) and contacts on magnetized projectile 232 are used to turn on and off the magnetic field of magnetized projectile 232 to create force to propel magnetized projectile 232 in direction 238.

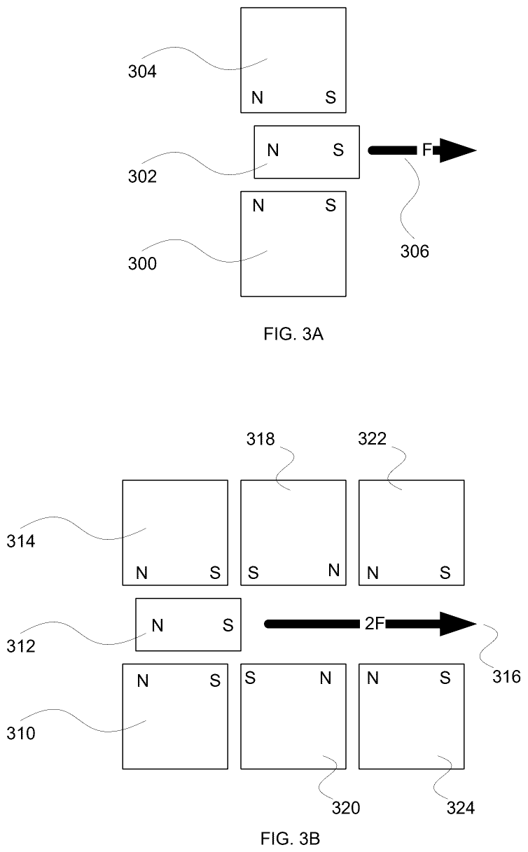

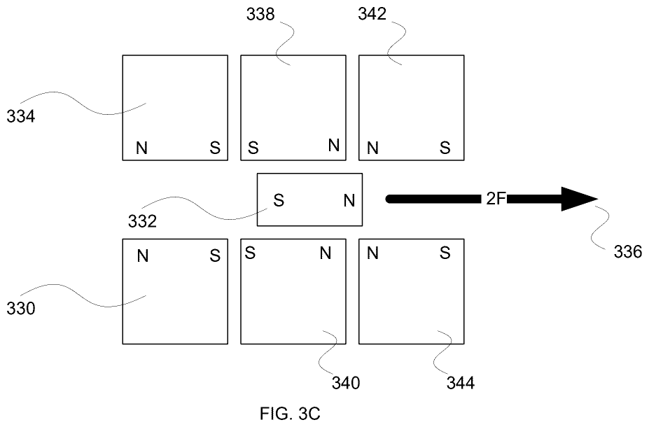

FIG. 3A is a diagram illustrating an embodiment of a slice view of system for projection. In some embodiments, projector magnet top slice 304 and projector magnet bottom slice 300 is representative of projector magnet 100 of FIG. 1A, projector magnet 110 of FIG. 1B, projector magnet 130 of FIG. 1C, projector magnet 200 and/or projector 204 of FIG. 2A, projector magnet 210 and/or projector magnet 214 of FIG. 2B, projector magnet 220 and/or projector magnet 224 of FIG. 2C, and/or projector magnet 230 and/or projector magnet 234 of FIG. 2D. In the example shown, projector magnet top slice 304 and projector magnet bottom slice 300 are used to create magnetic north pole on the left of the projector magnet and magnetic south pole on the right of the projector magnet. With magnetized projectile 302 having a magnetic north pole on the left of magnetized projectile 302 and a magnetic south pole on the right of magnetized projectile 302, magnetized projectile 302 experiences a force in direction 306 that will project magnetized projectile 302 away from projector magnet, which is comprised of projector magnet top slice 304 and projector magnet bottom slice 300. In some embodiments, projector magnet top slice 304 and projector magnet bottom slice 300 comprise a projector magnet that is one of a plurality of projector magnets with the same polarity of poles used to project magnetized projectile 302. In some embodiments, the plurality of projector magnets appropriately toggle the fields of magnetized projectile 302 to cause stages of projection force using appropriately placed electrodes that can enable magnetic field generation of magnetized projectile 302 (e.g., turning field on or off or switching polarity of field). In some embodiments, the toggling of the magnetic field of magnetized projectile 302 is caused by making and breaking electrical contact between the projector magnet electrodes and contacts on magnetized projectile 302. In some embodiments, the toggling of the magnetic field of magnetized projectile 302 is caused by providing current or not to the projector magnet electrodes.

FIG. 3B is a diagram illustrating an embodiment of a slice view of system for projection. In some embodiments, projector magnet top slice 314 and projector magnet bottom slice 310 is representative of a plurality of stages of projector magnets similar to projector magnet top slice 304 and projector magnet bottom slice 300 of FIG. 3A. In the example shown, projector magnet top slice 314 and projector magnet bottom slice 310 are part of a first projector magnet of a plurality of projector magnets. Projector magnet top slice 318 and projector magnet bottom slice 320 are part of a second projector magnet of a plurality of projector magnets. Projector magnet top slice 322 and projector magnet bottom slice 324 are part of a third projector magnet of a plurality of projector magnets. In various embodiments, there are any number of projector magnets in the system for projection—for example, 1, 2, 3, 4, 5, 6, 7, 8, 9, 10, 15, 20, 30, 40, 50, etc. projector magnets.

In the example shown, projector magnet top slice 314 and projector magnet bottom slice 310 are used to create magnetic north pole on the left of the projector magnet and magnetic south pole on the right of the projector magnet. Projector magnet top slice 318 and projector magnet bottom slice 320 are used to create magnetic south pole on the left of the projector magnet and magnetic north pole on the right of the projector magnet (the opposite of the first projector magnet). Projector magnet top slice 322 and projector magnet bottom slice 324 are used to create magnetic north pole on the left of the projector magnet and magnetic south pole on the right of the projector magnet (the opposite of the second projector magnet). In some embodiments, the magnetic fields of the plurality of projector magnets are alternating as shown in FIG. 3B. In some embodiments, the magnetic fields of the plurality of projector magnets are not alternating as shown in FIG. 3B; they are in the same direction.

With magnetized projectile 312 having a magnetic north pole on the left of magnetized projectile 312 and a magnetic south pole on the right of magnetized projectile 312 when positioned in the first projector magnet (which includes projector magnet top slice 314 and projector magnet bottom slice 310), magnetized projectile 312 experiences a force in direction 316 that will project magnetized projectile 312 away from the first projector magnet, which is comprised of projector magnet top slice 314 and projector magnet bottom slice 310. In addition, with magnetized projectile 312 having a magnetic north pole on the left of magnetized projectile 312 and a magnetic south pole on the right of magnetized projectile 312 when positioned in the first projector magnet (which includes projector magnet top slice 314 and projector magnet bottom slice 310), magnetized projectile 312 experiences an attractive force in direction 316 that will attract magnetized projectile 312 to the second projector magnet, which is comprised of projector magnet top slice 318 and projector magnet bottom slice 320.

FIG. 3C is a diagram illustrating an embodiment of a slice view of system for projection. In some embodiments, projector magnet top slice 334 and projector magnet bottom slice 330 is representative of a plurality of stages of projector magnets similar to projector magnet top slice 304 and projector magnet bottom slice 300 of FIG. 3A. In the example shown, projector magnet top slice 334 and projector magnet bottom slice 330 are part of a first projector magnet of a plurality of projector magnets. Projector magnet top slice 338 and projector magnet bottom slice 340 are part of a second projector magnet of a plurality of projector magnets. Projector magnet top slice 342 and projector magnet bottom slice 344 are part of a third projector magnet of a plurality of projector magnets. In various embodiments, there are any number of projector magnets in the system for projection—for example, 1, 2, 3, 4, 5, 6, 7, 8, 9, 10, 15, 20, 30, 40, 50, etc. projector magnets.

In the example shown, projector magnet top slice 338 and projector magnet bottom slice 340 are used to create magnetic south pole on the left of the projector magnet and magnetic north pole on the right of the projector magnet. Projector magnet top slice 342 and projector magnet bottom slice 344 are used to create magnetic north pole on the left of the projector magnet and magnetic south pole on the right of the projector magnet (the opposite of the second projector magnet). Projector magnet top slice 334 and projector magnet bottom slice 330 are used to create magnetic north pole on the left of the projector magnet and magnetic south pole on the right of the projector magnet (also the opposite of the second projector magnet). In some embodiments, the magnetic fields of the plurality of projector magnets are alternating as shown in FIG. 3C. In some embodiments, the magnetic fields of the plurality of projector magnets are not alternating as shown in FIG. 3C; they are in the same direction.

With magnetized projectile 332 having a magnetic south pole on the left of magnetized projectile 332 and a magnetic north pole on the right of magnetized projectile 332 (having switched polarities since when positioned in the first projector magnet) when positioned in the second projector magnet (which includes projector magnet top slice 338 and projector magnet bottom slice 340), magnetized projectile 332 experiences a force in direction 336 that will project magnetized projectile 332 away from the second projector magnet, which is comprised of projector magnet top slice 338 and projector magnet bottom slice 340. In addition, with magnetized projectile 332 having a magnetic south pole on the left of magnetized projectile 332 and a magnetic north pole on the right of magnetized projectile 332 when positioned in the second projector magnet (which includes projector magnet top slice 338 and projector magnet bottom slice 340), magnetized projectile 332 experiences an attractive force in direction 336 that will attract magnetized projectile 332 to the third projector magnet, which is comprised of projector magnet top slice 342 and projector magnet bottom slice 344. The switching of the magnetic field within magnetized projectile 332 is enabled by segmented electrodes placed along the path of magnetized projectile 332 in the inner bores of projector magnets, where the segmentation enables turning a magnetic field of magnetized projectile 332 on and off as well as changing its polarity when on by having different current directions provided to magnetized projectile 332.

In some embodiments, the multiple stages of projector magnets (whether in the same polarity or opposite) are used to impart more and more energy into a magnetized projectile.

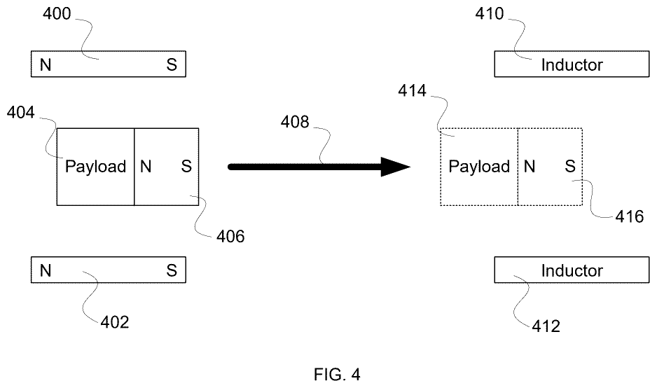

FIG. 4 is a diagram illustrating an embodiment of a slice view of a system for projection and capture. In the example shown, projector magnet top slice 400 and projector magnet bottom slice 402 with magnetic field north pole on the left side of the projector magnet and magnetic field south pole on the right side of the projector magnet propels in direction 408 magnetized projectile 406 (with magnetic field north pole on the left side of magnetized projectile 406 and magnetic field south pole on the right side of magnetized projectile 406) along with its attached payload 404. When magnetized projectile 406 and payload 404 enters capture inductor (with top capture inductor slice 410 and bottom capture inductor slice 412) as shown in FIG. 4 with the dotted position of magnetized projectile 416 and payload 414, a force is generated that opposes the motion of entry. This force will be generated until the motion stops or until the magnetized projectile (either magnetized projectile 406 or dotted later version magnetized projectile 416) moves outside the capture inductor.

In some embodiments, the system for projection and capture is used to transport payloads to and from ships in space. In some embodiments, the system for projection is used to transport a payload from a ship in space to planet. In some embodiments, once captured magnets can be used to dock the projectile with a ship. In various embodiments, the inductor comprises a large cylinder shape, a large cone shape, or any other appropriate shape. In various embodiments, the capturing inductor is combined with a projector magnet so that once captured the payload or vehicle can be projected to another location or back to where it arrived from.

In some embodiments, magnetism induction can provide cheaper, lighter, simpler and more sustainable spacecraft docking in addition to and in replacement of current rocket technology. Induction docking involves one spacecraft with magnets which are moved into another spacecraft with induction conductor tubes. The magnets induce electric currents in the induction conductor tubes. These induced electric currents in turn generate induced magnet fields which oppose the magnet moving in the inductor. This magnetic opposition decelerates the incoming relative velocity vector of the spacecraft. When the spacecraft stops, the induction ceases automatically. In some embodiments, magnets can be superconductor solenoids cooled at ambient temperature or cryocooled. In some embodiments, induction reduces risks compared to current rocket docking in two ways: a) induction decelerates regardless of the orientation of the spacecraft nor the angle of approach; and 2) induction efficiently brings spacecraft to an automatic stop. Once stopped the magnet can be led to final physical docking by powering electro-or superconductor solenoid magnets at the end of the induction tube. In some embodiments, induction docking offers less weight, expense, risk and less fuel, which results in energy savings for lower cost, lower power budgets, and less maintenance. In some embodiments,

In some embodiments, the induction conductor tubes comprise solenoids made of one or more of the following materials: metals, low temperature superconductors, high temperature superconductors, high temperature superconductor tapes or wires, or any other appropriate material.

In some embodiments, the induction conduction tube comprises multiple concentric tubes along the flight path illustrated. In some embodiments, the induction conduction tube comprises one continuous tube.

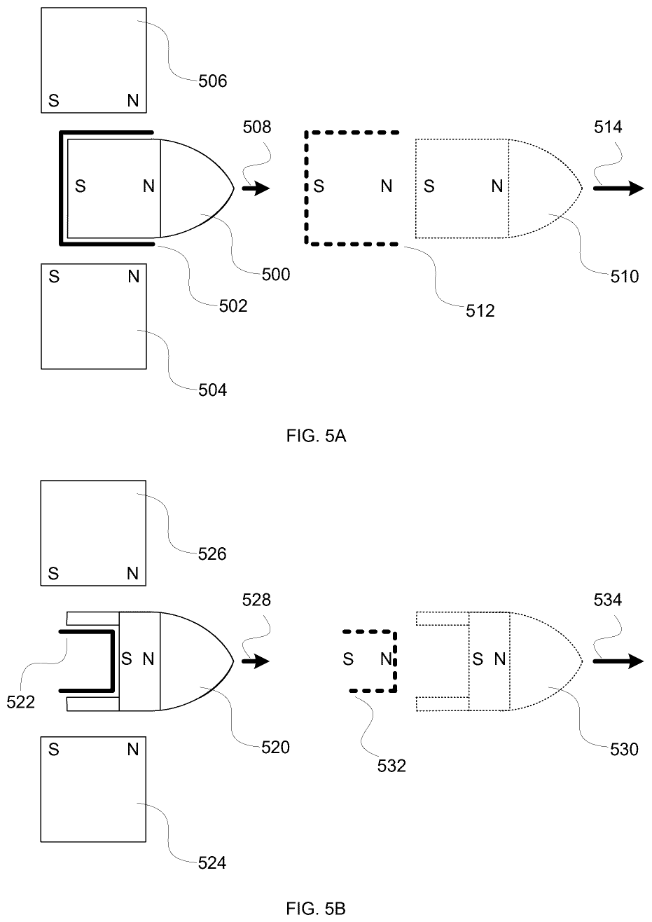

FIG. 5A is a diagram illustrating an embodiment of a system for projection with multiple stages. In the example shown, top projector magnet slice 506 and bottom projector magnet slice 504 propels in direction 508 magnetic projectile 500 and attached sabot 502 using magnetic south pole on the left of projector magnet and magnetic north pole on the right of projector magnet which creates a force against magnetic south pole on the left side of magnetic projectile 500 and magnetic north pole on the right side of magnetic projectile 500. A second stage for propulsion (e.g., in direction 514) uses a force generated by magnetic field of sabot 512 (which is sabot 502 after having traveled to the right in direction 508) with magnetic south pole on left side of sabot 512 and magnetic north pole on right side of sabot 512 which opposes magnetic projectile 510 (with magnetic south pole on left side of magnetic projectile 510 and magnetic north pole on right side of magnetic projectile 510). In some embodiments, sabot 512 uses an internal power source to energize the magnetic field at a specific time of travel.

In some embodiments, the system for projection has multiple stages to accelerate projectiles using a projectile with multiple nested solenoid sabot layers. Each sabot has an independent power source which is first activated when a sabot is being launched and then later when the sabot is launching the next sabot. After a first launch, the first solenoid sabot layer and the next solenoid sabot layer can be activated to create opposing magnetic fields with electric currents. This will cause the projectile with remaining sabot solenoids to be propelled from the first solenoid sabot. Repeating the process would further propel the magnetized projectile with remaining solenoid sabot layers. In the example shown in FIG. 5A, there is only one sabot (e.g., sabot 512), however, in some cases there are multiple sabots nested around the magnetized projectile (e.g., magnetized projectile 500 or 510) to create multiple stages for acceleration.

Sabot launch timing can be determined by sensors (e.g., a time sensor, an altitude sensor, a location sensor, a distance sensor, speed sensor, etc.). In various embodiments, a sabot could be launched when sabot speed has slowed below a threshold, a certain time from the previous launch, a certain altitude, distance, or location has been reached, etc.

In some embodiments, the trigger is processed by a processor receiving a signal from a sensor. The processor is coupled to one or more batteries and/or other power source in the magnetized projectile that is able to power the processor, the sensor, and/or provide current to create the sabot magnetic fields.

FIG. 5B is a diagram illustrating an embodiment of a system for projection with multiple stages. In the example shown, top projector magnet slice 526 and bottom projector magnet slice 524 propels in direction 528 magnetic projectile 520 and attached sabot 522 using magnetic south pole on the left of projector magnet and magnetic north pole on the right of projector magnet which creates a force against magnetic south pole on the left side of magnetic projectile 520 and magnetic north pole on the right side of magnetic projectile 520. A second stage for propulsion (e.g., in direction 534) uses a force generated by magnetic field of sabot 532 (which is sabot 522 after having traveled to the right in direction 528) with magnetic south pole on left side of sabot 532 and magnetic north pole on right side of sabot 532 which opposes magnetic projectile 530 (with magnetic south pole on left side of magnetic projectile 530 and magnetic north pole on right side of magnetic projectile 530). In some embodiments, sabot 532 uses an internal power source to energize the magnetic field at a specific time of travel.

In some embodiments, the system for projection (e.g., a dipole coilgun) uses multiple stages to accelerate projectiles using a projectile with multiple nested solenoid sabot layers. Each sabot has an independent power source which is first activated when a sabot is being launched and then later when the sabot is launching the next sabot. After a first launch, the first solenoid sabot layer and the next solenoid sabot layer can be activated to create opposing magnetic fields with electric currents. This will cause the projectile with remaining sabot solenoids to be propelled from the first solenoid sabot. Repeating the process would further propel the magnetized projectile with remaining solenoid sabot layers. In the example shown in FIG. 5B, there is only one sabot (e.g., sabot 532), however, in some cases there are multiple sabots nested around the magnetized projectile (e.g., magnetized projectile 520 or 530) to create multiple stages for acceleration.

In some embodiments, sabot launch timing can be determined by sensors (e.g., a time sensor, an altitude sensor, a location sensor, a distance sensor, speed sensor, etc.). In various embodiments, a sabot could be launched when sabot speed has slowed below a threshold, a certain time from the previous launch, a certain altitude, distance, or location has been reached, etc.

In some embodiments, the trigger is processed by a processor receiving a signal from a sensor. The processor is coupled to one or more batteries and/or other power source in the magnetized projectile that is able to power the processor, the sensor, and/or provide current to create the sabot magnetic fields.

In various embodiments, one or more external sabots around a magnetized projectile (e.g., as described in FIG. 5A) are combined with one or more internal sabots in a magnetized projectile (e.g., as described in FIG. 5B). In some embodiments, a back end of the a master sabot has multiple nested sabots and a front end of the master sabots has multiple nested sabots with a magnetized projectile in the most nested sabot stage.

In some embodiments, a magnetized projectile/Sabot contains an electric source such as a battery or external electric contacts, and conductor systems which will cause the projectile to spin when moving in a magnetic field such as that inside a projector magnet. For example, a battery or other current source which enables current generation between the center of the projectile and the edge of the projectile will cause a rotational force as the current passes through a magnetic field of a solenoid causing the magnetized projectile to spin.

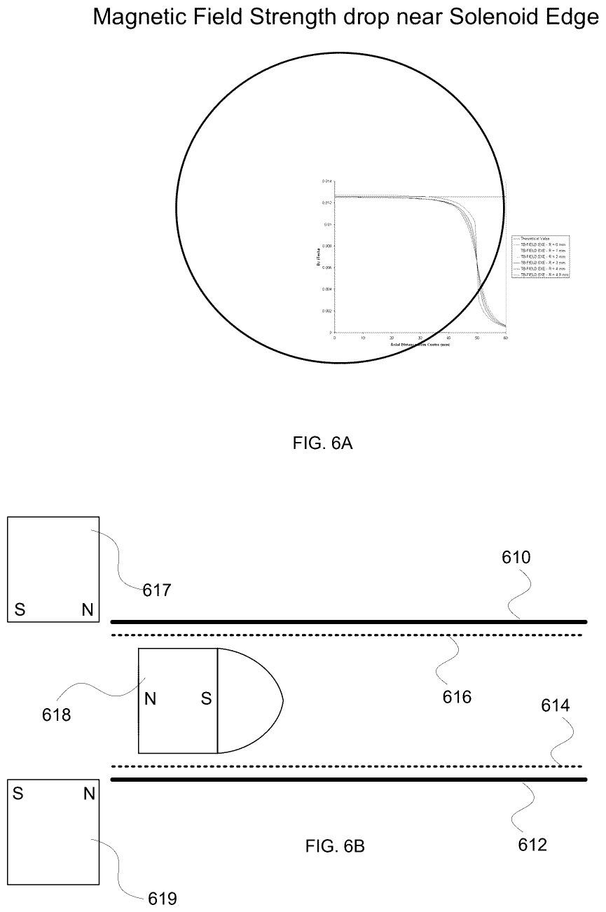

FIG. 6A is a diagram illustrating an embodiment of a frictionless barrel. In the example shown, magnetic field strength drop near the edge of a solenoid is shown.

FIG. 6B is a diagram illustrating an embodiment of a slice view of a frictionless barrel. In the example shown, magnetized projectile 618 is within two solenoid interiors of a frictionless barrel (e.g., a first solenoid with top edge 616 and bottom edge 614 and a second solenoid with a top edge 610 and bottom edge 612. In some embodiments, once magnetized projectile 618 is projected from a solenoid (e.g., solenoid with top slice 617 and bottom slice 619), magnetized projectile 618 can be directed toward a target with a frictionless barrel. This frictionless barrel can comprise a set of magnetic fields that provide a combined set of magnetic forces to keep magnetized projectile 618 from the walls of the frictionless barrel. The attractive forces created between the frictionless barrel and magnetized projectile 618 will act to separate magnetized projectile 618 from the frictionless barrel. This is because the magnetic field within a solenoid declines closer to the edges of the solenoid wires leaving the strongest attractive magnetic forces in the middle of the solenoid away from its edges. This produces a radial force on the magnetized projectile which keeps magnetized projectile 618 away from the Solenoid's edges reducing friction.

In some embodiments, solenoids of a frictionless barrel are made of metal conductors such as copper or silver, or High Temperature Superconductors, or Reinforced High Temperature Superconductors, or Low Temperature Superconductors, or any material which conducts electricity thereby creating a magnetic field within the solenoid.

In some embodiments, a magnetized projectile is held before launching within projector magnet by a magnetic latch solenoid with an attractive magnetic polarity to the magnetized projectile. The magnetic latch solenoid is on its own separate electric circuit. When the magnetic latch solenoid current is turned off, the magnetic latch solenoid's magnetic field ends and the magnetized projectile is free to be ejected from the projector magnet.

In some embodiments, liquid nitrogen is used to cool High Temperature Superconductor magnets of the projector magnets and/or the magnetized projectiles. Liquid nitrogen generates expanding gaseous nitrogen, which can be used to help propel a projectile from a projector magnet.

In some embodiments, the gaseous nitrogen pressure is used to separate a sabot from the magnetized projectile, which facilitates sabot collection for reuse and adds propulsion to the magnetized projectile.

In some embodiments, the system for magnetic projection is non-destructive unlike the chemical explosions now required by rocket, artillery, guns, and other propulsion methods with components including solenoids, sabots, and other equipment that can be reused with minimum repair or refurbishment. This allows projectiles to be launched at much lower costs than current technology, which require disposal or destruction of equipment after each launch such as rockets or shells with costly re-equipping and preparation for a next launch.

In some embodiments, magnetized projectiles can be launched externally or internally to a sabot. In some embodiments, multiple magnetized projectiles can be launched at the same time lowering costs even more.

In some embodiments, the system for magnetic projection is deployed in outer space where some superconductors can work without direct cooling. Where space is not cold enough for superconductivity at ambient space temperatures such close to Earth or when solar radiant heating raises temperatures, superconductors can be cooled using liquid helium, liquid nitrogen, or cryocooling. In some embodiments where ambient space temperatures are too high for superconductivity, reinforced and unreinforced High Temperature Superconductors cooled with liquid nitrogen can be used in Dipole Coilguns to create the strong magnetic fields needed for launching magnetized projectiles.

In various embodiments, the system for magnetic projection in space is used for transporting equipment, fuel, space debris, and astronauts, or any other appropriate transportation use. In various embodiments, the system for magnetic projection in space is used for launching projectiles and missiles at other spacecraft or towards earth.

In various embodiments, the system for magnetic projection in space is used to launch magnetized projectiles such as satellites, payloads, and unmanned capsules into Outer Space. Because the system for magnetic projection in space does not involve destructive chemical reactions to provide force like currently used rocket technology, launching components can be easily recovered and reused with minimal repair and restoration. In various embodiments, the system for magnetic projection in space is used for efficiently focusing nearly all energy into force along the axis of propulsion which avoids the need to contain the disruptive excess energy of rocket chemical explosions. These factors will make the system for magnetic projection cheaper, safer, and less risky than current rocket technology.

In some embodiments, rocket propulsion stages are combined with the system for magnetic projection in various stages to optimize performance and cost.

In some embodiments, the system for magnetic projection is deployed in a chain of low earth orbit (LEO) satellites to launch anti-ballistic warheads against ballistic and hypersonic missiles in boost-phase. Some embodiments use superconductors under cyrocooling or at ambient temperature in a system for magnetic projection. In some embodiments, the system for magnetic projection can use solar powered electric energy which is renewable compared to rocket fuel.

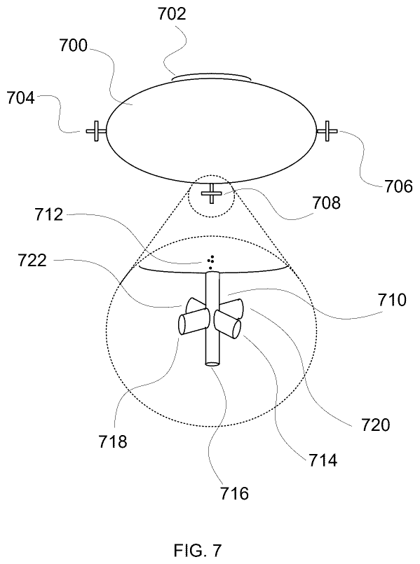

FIG. 7 is a diagram illustrating an embodiment of a system for asteroid propulsion. In some embodiments, the system for magnetic projection uses solar power from solar energy panels and/or nuclear reactors to propel ferromagnetic material from asteroids to move asteroids in space. In the example shown, asteroid 700 includes asteroid propulsion systems (APS) 704, APS 706, and APS 708 (which is shown in a larger view as APS 710). APS's would allow valuable asteroids to be moved closer to Earth and/or the Moon for mining valuable metals, materials, and other substances from asteroids and/or for converting asteroids into spacecraft, space stations, and other objects for use in outer space. The system includes source of power 702 (e.g., a solar panel and/or nuclear reactor) which are electrically connected to APS or other systems that require power. The system further includes a mining unit to produce materials (e.g., materials 712) by grinding material propulsion sand from the asteroid using laser cutting or grinding abrasives from Earth such as, but not limited to, natural and or synthetic diamonds, carbide compounds, etc. In some embodiments, each APS (e.g., APS 704, APS 706, APS 708, and/or 710) comprises five projector magnets (e.g., projector magnet 714, projector magnet 716, projector magnet 718, projector magnet 720, and projector magnet 722) oriented in an orthogonal cross with the fifth projector magnet (e.g., projector magnet 716) pointed directly away from the asteroid surface; The fifth projector magnet (e.g., projector magnet 716) would be the propulsion unit for the APS; The other four projector magnets (e.g., projector magnet 714, projector magnet 718, projector magnet 720, and projector magnet 722) would be lateral or attitude propulsion units. In some embodiments, materials 712 comprises a ferromagnetic propulsion sand that is used for propulsion by being ejected out of one or any combination of the five projector magnets at great force by the magnetic field created by the projector magnet when activated with power; This force will cause a counter reactive force on the asteroid causing the asteroid to move in the opposite direction, and/or turn radially around its center of gravity, and/or any other combination thereof. In some embodiments, multiple APS's at different locations on an asteroid would permit movement and rotation in any direction including complex turns. In some embodiments, signal stations enable control of the APS's from Earth and thus asteroid movement from Earth.

In some embodiments, the APS's could slow an asteroid's speed causing it to lose energy and fall inward toward the Sun until it reaches Earth orbit. Once near Earth orbit, the Asteroid could be parked in a stable position near Earth in either: a) one of Earth's several Lagrange Points, b) orbit around Earth, c) orbit around the Moon, or d) crashed into the Moon. From that stable position, the asteroid could be mined for material and/or converted into vehicles and structures for space travel and habitation.

Control over a ferromagnetic asteroid's approach to Earth can be enhanced by solar/nuclear powered HTS Solenoids on the Moon. The solenoids can create a magnetic field which will attract the ferromagnetic asteroid toward Earth orbit and the Moon.

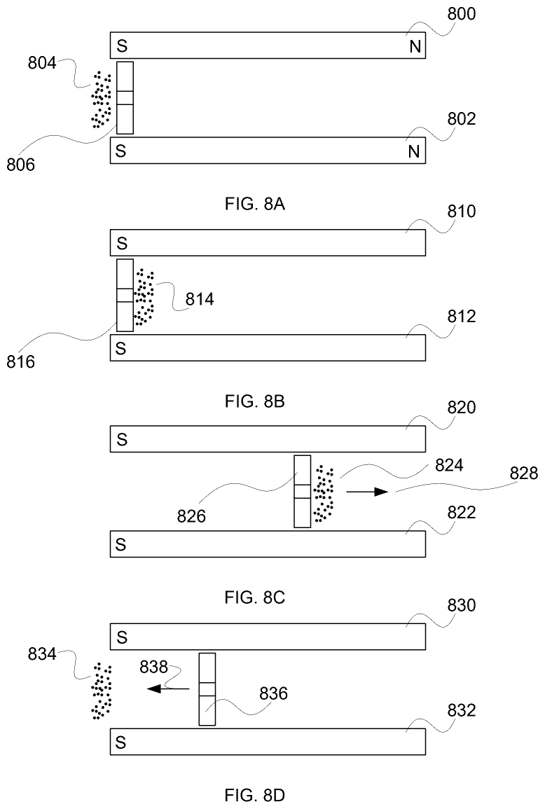

FIG. 8A is a diagram illustrating an embodiment of propelling material for an asteroid propulsion system. In some embodiments, projector magnet of FIG. 8A is used to implement a projector magnet of an asteroid propulsion system (e.g., projector magnet 720, projector magnet 714, projector magnet 716, projector magnet 718, and/or projector magnet 722 of FIG. 7). In the example shown, material 804 (e.g., ground asteroid material) is positioned outside projector magnet with top slice of projector magnet 800 and bottom slice projector magnet 802 with magnetized projectile disk 806.

FIG. 8B is a diagram illustrating an embodiment of propelling material for an asteroid propulsion system. In some embodiments, projector magnet of FIG. 8B is used to implement a projector magnet of an asteroid propulsion system (e.g., projector magnet 720, projector magnet 714, projector magnet 716, projector magnet 718, and/or projector magnet 722 of FIG. 7). In the example shown, material 814 (e.g., ground asteroid material) is moved from outside projector magnet with top slice of projector magnet 810 and bottom slice projector magnet 812 to other side of magnetized projectile disk 816 (e.g., moved by mechanically moving material 804 of FIG. 8A through an opened aperture of magnetized projectile disk 816 and closing aperture after moving to position of material 814 of FIG. 8B).

FIG. 8C is a diagram illustrating an embodiment of propelling material for an asteroid propulsion system. In some embodiments, projector magnet of FIG. 8C is used to implement a projector magnet of an asteroid propulsion system (e.g., projector magnet 720, projector magnet 714, projector magnet 716, projector magnet 718, and/or projector magnet 722 of FIG. 7). In the example shown, material 824 (e.g., ground asteroid material) is propelled using projector magnet with top slice of projector magnet 820 and bottom slice projector magnet 822 using magnetized projectile disk 826 in direction 828.

FIG. 8D is a diagram illustrating an embodiment of propelling material for an asteroid propulsion system. In some embodiments, projector magnet of FIG. 8D is used to implement a projector magnet of an asteroid propulsion system (e.g., projector magnet 720, projector magnet 714, projector magnet 716, projector magnet 718, and/or projector magnet 722 of FIG. 7). In the example shown, after projecting a last bunch of material, magnetized projector disk 836 is returned in direction 828 to collect new material 834 (e.g., ground asteroid material) as next bunch to propel using projector magnet with top slice of projector magnet 830 and bottom slice projector magnet 832.

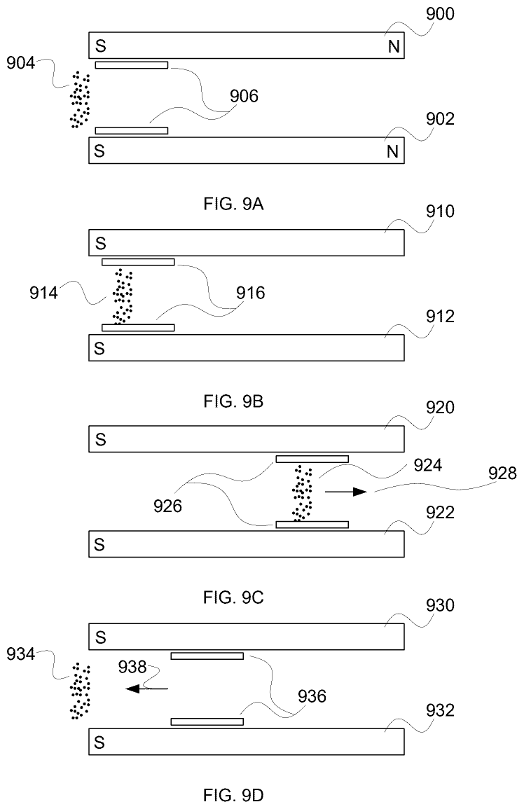

FIG. 9A is a diagram illustrating an embodiment of propelling ferromagnetic material for an asteroid propulsion system. In some embodiments, projector magnet of FIG. 9A is used to implement a projector magnet of an asteroid propulsion system (e.g., projector magnet 720, projector magnet 714, projector magnet 716, projector magnet 718, and/or projector magnet 722 of FIG. 7). In the example shown, ferromagnetic material 904 (e.g., ground asteroid material such as from 16 Psyche) is positioned outside projector magnet with top slice of projector magnet 900 and bottom slice projector magnet 902 with magnetized projectile solenoid 906.

FIG. 9B is a diagram illustrating an embodiment of propelling ferromagnetic material for an asteroid propulsion system. In some embodiments, projector magnet of FIG. 9B is used to implement a projector magnet of an asteroid propulsion system (e.g., projector magnet 720, projector magnet 714, projector magnet 716, projector magnet 718, and/or projector magnet 722 of FIG. 7). In the example shown, ferromagnetic material 914 (e.g., ground asteroid material) is moved from outside projector magnet with top slice of projector magnet 910 and bottom slice projector magnet 912 to other side of magnetized projectile disk 916 (e.g., moved by mechanically moving material 904 of FIG. 9A through the open aperture of magnetized projectile solenoid 916 and after moving to position of ferromagnetic material 914 of FIG. 9B).

FIG. 9C is a diagram illustrating an embodiment of propelling ferromagnetic material for an asteroid propulsion system. In some embodiments, projector magnet of FIG. 9C is used to implement a projector magnet of an asteroid propulsion system (e.g., projector magnet 720, projector magnet 714, projector magnet 716, projector magnet 718, and/or projector magnet 722 of FIG. 7). In the example shown, ferromagnetic material 924 (e.g., ground asteroid material) is propelled using projector magnet with top slice of projector magnet 920 and bottom slice projector magnet 922 using magnetized projectile solenoid 926 in direction 928.

FIG. 9D is a diagram illustrating an embodiment of propelling ferromagnetic material for an asteroid propulsion system. In some embodiments, projector magnet of FIG. 9D is used to implement a projector magnet of an asteroid propulsion system (e.g., projector magnet 720, projector magnet 714, projector magnet 716, projector magnet 718, and/or projector magnet 722 of FIG. 7). In the example shown, after projecting a last bunch of ferromagnetic material, magnetized projector solenoid 936 is returned in direction 928 to collect new ferromagnetic material 934 (e.g., ground asteroid material) as next bunch to propel using projector magnet with top slice of projector magnet 930 and bottom slice projector magnet 932.

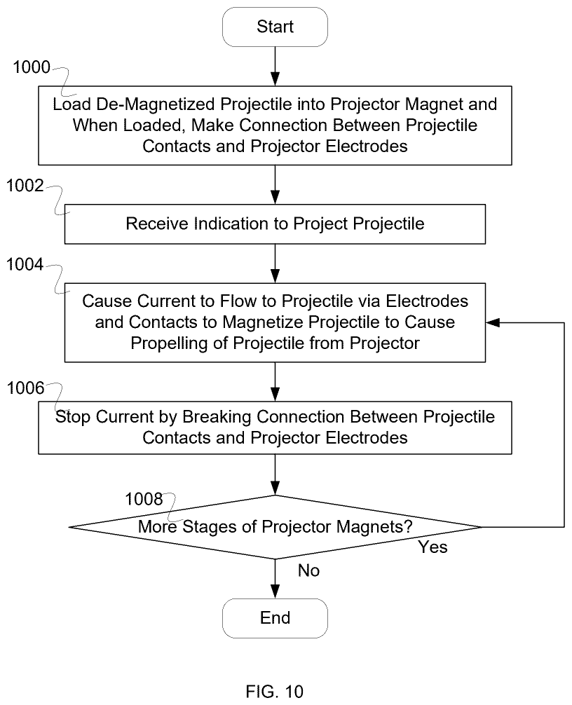

FIG. 10 is a flow diagram illustrating an embodiment of a process for a system for projecting a projectile. In some embodiments, the process of FIG. 10 is used in execution of FIG. 1A, FIG. 1B, FIG. 1C, FIG. 2A, FIG. 2B, FIG. 2C, FIG. 2D, FIG. 3A, FIG. 3B, and/or FIG. 3C. In the example shown, in 1000 a de-magnetized projectile is loaded into projector magnet and, when loaded, makes connection between projectile contacts and projector electrodes. For example, the projectile is moved into the projector and the contacts on the projectile are made to connect with the electrodes on the inner diameter of the projector.

In 1002, an indication is received to project the projectile. For example, an indication to project the projectile is received (e.g., a button push creates an electrical signal to a processor, a user interface button is selected, etc.).

In 1004, current is caused to flow to projectile via electrodes and contacts to magnetize projectile to cause propelling of projectile from projector. For example, a processor causes current to flow to electrodes on inner diameter of projector to contacts on projectile which causes a current to flow in a solenoid on projectile. The resultant magnetic field opposes the magnetic field of the projector, and the projectile is propelled out of the projector.

In 1006, current is stopped by breaking connection between projectile contacts and projector electrodes. For example, the electrode on the projector ends and the contacts on the projectile break connection with the electrodes as the projectile is propelled from the interior of the projector. This turns the projectile magnetic field off.

In 1008, it is determined whether there are more stages of projector magnets. For example, the projectile connects with a new set of electrodes of a next stage as the projectile moves forward. In response to determining that there are more stages, control passes to 1004. In response to determining that there are not more stages, the process ends.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a projector magnet, wherein the projector includes a friction reducing solenoid; and
a magnetized projectile, wherein the projector magnet and the magnetized projectile have opposing magnetic fields causing the magnetized projectile to be projected out of the projector magnet.

2. The system of claim 1, wherein the magnetized projectile has a magnetic field created by a permanent magnet or by a projectile solenoid.

3. The system of claim 2, wherein the projectile solenoid comprises one or more of: metal conductors, high temperature superconductors, reinforced high temperature superconductors, and/or low temperature superconductors.

4. The system of claim 1, wherein the projector magnet comprises one or more of: metal conductors, high temperature superconductors, reinforced high temperature superconductors, and/or low temperature superconductors.

5. The system of claim 1, wherein the projector magnet includes electrodes for providing current to a magnetized projectile, and wherein the magnetized projectile includes contacts for electrically connecting to the electrodes.

6. The system of claim 1, wherein the projector magnet includes grooves for maintaining rotational orientation between the projector magnet and the magnetized projectile.

7. The system of claim 6, wherein the grooves are straight or spiraled.

8. The system of claim 1, further comprising one or more additional projector magnets.

9. The system of claim 8, wherein the projector magnet and the one or more additional projector magnets have magnetic fields oriented in a same direction.

10. The system of claim 8, wherein the projector magnet and the one or more additional projector magnets have magnetic fields oriented in alternating directions.

11. The system of claim 8, wherein the projector magnet and the one or more additional projector magnets have electrodes for switching on a magnetic field of the magnetized projectile.

12. The system of claim 8, further comprising a guide, wherein the guide guides the magnetized projectile between the projector magnet and one of the one or more projector magnets or between a second projector magnet of the one or more projector magnets and a third projector magnet of the one or more projector magnets.

13. The system of claim 12, wherein the guide selectively omits electrodes to switching off the magnetic field of the magnetized projectile at desired positions.

14. The system of claim 1, wherein the magnetized projectile includes a current source to switch on a magnetic field of the magnetized projectile for inductive capture.

15. The system of claim 1, wherein the projector or the magnetized projectile comprise one or more stages for projection.

16. The system of claim 1, wherein the magnetized projectile projects material.

17. The system of claim 1, wherein the magnetized projectile projects ferromagnetic material.

18. A method, comprising:
providing a projector magnet for a projector, wherein the projector includes a friction reducing solenoid; and
providing a magnetized projectile, wherein the projector magnet and the magnetized projectile have opposing magnetic fields causing the magnetized projectile to be projected out of the projector magnet.

19. A method, comprising:
receiving indication to project projectile from a projector, wherein the projector includes a friction reducing solenoid;
causing current to flow to projectile via electrodes and contacts to magnetize projectile to cause propelling of projectile from projector; and
stopping current by breaking connection between projectile contacts and projector electrodes.
